(19) United States
(12) Patent Application Publication
(10) Pub. No.: US 2008/0037737 A1
(43) Pub. Date: Feb. 14, 2008

(54) SYSTEM AND METHOD FOR EFFECTING AUTOMATIC TRANSFER OF TELEPHONE CALLS

(75) Inventor: Eric C. D. Lenington, Addison, TX (US)

Correspondence Address: HITT GAINES P.C., P.O. BOX 832570, RICHARDSON, TX, 75083, US

(73) Assignee: Intelemedia Communications, Plano, TX (US)

(21) Appl. No.: 11/877,588

(22) Filed: Oct. 23, 2007

Related U.S. Application Data
(63) Continuation of application No. 09/580,165, filed on May 30, 2000.

(51) Int. Cl. H04M 11/00; H04M 3/42

(52) U.S. Cl. 379/93.05; 379/212.01

(57) ABSTRACT

For use with call transfer circuitry associated with a central office, an automatic transferring system and method for automatically transferring a telephone call from a called party to a subsequent party and a surveying system incorporating the system or the method. In one embodiment, the automatic transferring system includes: (1) a call termination detector that detects termination of the telephone call by the called party and (2) signaling circuitry, associated with the call termination detector and dissociated from the called party, that, in response to the termination, signals the call transfer circuitry to automatically transfer the telephone call to the subsequent party without requiring equipment associated with the called party to cause the transfer.

### CROSS REFERENCE TO RELATED APPLICATION

This application is a continuation of U.S. patent application Ser. No. 09/580,165, entitled “SYSTEM AND METHOD FOR EFFECTING AUTOMATIC TRANSFER OF TELEPHONE CALLS,” filed on May 30, 2000, by Eric C. D. Lenington, which is currently pending. The above-listed application is commonly assigned with the present invention and is incorporated herein by reference as if reproduced herein in its entirety.

### TECHNICAL FIELD OF THE INVENTION

The present invention is directed, in general, to telephone systems and, more specifically, to a system and method for effecting automatic transfer of telephone calls.

### BACKGROUND OF THE INVENTION

Business in modern society has steadily evolved over the last several decades into an environment where little or no business is ever conducted in person. Not surprising, competition between telecommunications companies (e.g., AT&T, Sprint and MCI) has correspondingly increased as these companies struggle to gain an edge in the market.

Absolutely essential for a company to succeed in today's business climate is a telephone system capable of handling the ever-increasing influx of calls from customers. To meet this demand, most telecommunications companies provide some type of system capable of call transfers for their customers. With a system capable of call transferring, modern businesses can centralize locations for handling customer calls, as well as allow companies the ability to transfer certain calls to appropriate persons once the purpose of those calls has been determined. Of course, calls that require transfer come not only from new customers eager to do business, but also from past customers contacting the company seeking some type of customer service.

Those skilled in the art understand that good customer service is a fundamental key to success in today's market. As a result, customer service has quickly become a benchmark that most companies strive to improve, placing an increased strain on the performance required of call transfer systems. For example, companies may use their call transfer system to assist in conducting customer satisfaction surveys regarding a customer's experience with a particular customer service representative (CSR).

The typical call transfer systems found in the prior art operate essentially in the same manner. A customer first telephones a company's customer service line (or other similar service). Then, after conversing with a CSR, or perhaps an interactive voice response system (IVR), the customer's call may require a transfer to another location. To transfer the call, the CSR must first terminate his conversation with the customer and then perform some action to initiate a call transfer.

Since most prior art central office (CO) call transfer equipment responds to dual-tone multifrequency (DTMF) codes, the CSR typically initiates the call transfer by manually entering the appropriate DTMF codes. Thus, a critical disadvantage of many call transfer systems found in the prior art becomes apparent: the CSR must manually initiate the call transfer.

In addition, although prior art call transfer systems may be adequate to handle the volume of incoming calls, their active transfer requirement may render them ill-suited to administer the customer satisfaction surveys discussed above. For example, when a customer calls a company's customer service line, he may be informed that the company would like to survey the customer after the completion of his call to determine the performance of the CSR. Although the prior art systems allow such a call transfer to be made (transferring the customer from the CSR to the surveyer), the CSR about whom the survey is to be conducted is made aware of the survey, because he must manually initiate transfer of the customer's call once their conversation has concluded. Because the CSR is aware of the imminent survey, the CSR is likely to behave differently than without such knowledge. As a result, accurate survey results regarding the true behavior of the CSR are unlikely to be had.

However, there do exist in the prior art call transfer systems that automatically transfer or forward calls from one party to another without the called party becoming aware of the transfer. Such systems incorporate an automatic call director (ACD) to automatically transfer a telephone call at its conclusion. Unfortunately, even those businesses having ACDs incorporated into their telephone systems must still reprogram or otherwise modify those ACDs, often at substantial expense, to automatically transfer or forward calls to subsequent parties not already programmed into the ACD. Moreover, even if the subsequent party were already programmed into the ACD, transfer equipment associated with the called party (i.e., the ACD itself) is still required to initiate the automatic transfer.

Accordingly, what is needed in the art is a call transfer system for automatically transferring a telephone call from a called party to a subsequent party that does not require participation by, or equipment associated with, the called party to complete the transfer.

### SUMMARY OF THE INVENTION

To address the above-discussed deficiencies of the prior art, the present invention provides, for use with all call transfer circuitry (such as AT&T Transfer Connect® circuitry) associated with a CO, an automatic transferring system and method for automatically transferring a telephone call from a called party to a subsequent party and a surveying system incorporating the system or the method. In one embodiment, the automatic transferring system includes: (1) a call termination detector that detects termination of the telephone call by the called party and (2) signaling circuitry, associated with the call termination detector and dissociated from the called party, that, in response to the termination, signals the call transfer circuitry to automatically transfer the telephone call to the subsequent party without requiring equipment associated with the called party to cause the transfer.

The present invention therefore introduces the broad concept of automatically transferring calls without requiring action on the part of either the calling or called parties (beyond the called party hanging up), or any equipment associated with either the calling or called parties. The present invention enjoys substantial utility in that the called party's equipment does not need to be modified to effect transfers, and the transfer can be transparent to the equipment associated with the called party (thereby enhancing the blindness of surveys taken with respect to interactions between the calling party and the called party).

In one embodiment of the present invention, the system is collocated with the call transfer circuitry (at the CO). Of course, this need not be the case; the system may be located remotely from the CO and employ one or more trunks to effect detecting and signaling (and optional calling party messaging).

In one embodiment of the present invention, the signaling circuitry signals the call transfer circuitry in-band. In an embodiment to be illustrated and described, the signaling circuitry employs dual-tone multifrequency (DTMF) signaling to signal the call transfer circuitry appropriately. Out-of-band signaling can, however, be employed and is well within the broad scope of the present invention.

In one embodiment of the present invention, the called party and the equipment are unable to detect the transfer. Again, the present invention requires no modification to the called party's equipment and, in an advantageous embodiment to be described in greater detail, can operate transparently with respect to the equipment and the called party to enhance the blindness of surveys that may be taken with respect to the called party.

In one embodiment of the present invention, the system further includes sampling circuitry, associated with the call termination detector, that selects the telephone call for the transfer in response to the termination. The sampling circuitry, while not required by the present invention, can select telephone calls pseudo randomly, according to some function or in any other manner.

In one embodiment of the present invention, the system further includes messaging circuitry, associated with the call termination detector, that transmits a message regarding the transfer to a calling party of the telephone call before the calling party is connected to the called party. In an embodiment to be illustrated and described, the messaging circuitry asks the calling party the favor of staying on the line after the called party terminates the telephone call. Thus, the calling party is informed that an automatic transfer will take place and is dissuaded from hanging up upon termination. The messaging circuitry may otherwise inform or prompt the calling party in any advantageous manner.

In one embodiment of the present invention, the subsequent party comprises a surveyer that surveys a calling party of the call regarding interaction between the calling party and the called party. The surveyer may include an IVR, voice recognition unit or live operator. The surveyer may act in any conventional or later-discovered manner to survey the calling party with respect to his interaction with the called party. In one advantageous embodiment of the present invention, the called party is an inbound calling center, built around an ACD and including an attendant bank. Surveying the performance of the attendant bank without modifying operation of the ACD or tipping off the attendant bank is highly advantageous.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 illustrates an environment with which a system for automatically transferring a telephone call can operate;

FIG. 2 illustrates a system for automatically transferring a telephone call from one party to another constructed according to the principles of the present invention;

FIG. 3 illustrates a surveying system, incorporating the system of FIG. 2 and operating within the environment of FIG. 1, that is constructed according to the principles of the present invention; and

FIG. 4 illustrates a flow diagram of a method of automatically transferring a telephone call from a called party to a subsequent party carried out according to the principles of the present invention.

### DETAILED DESCRIPTION

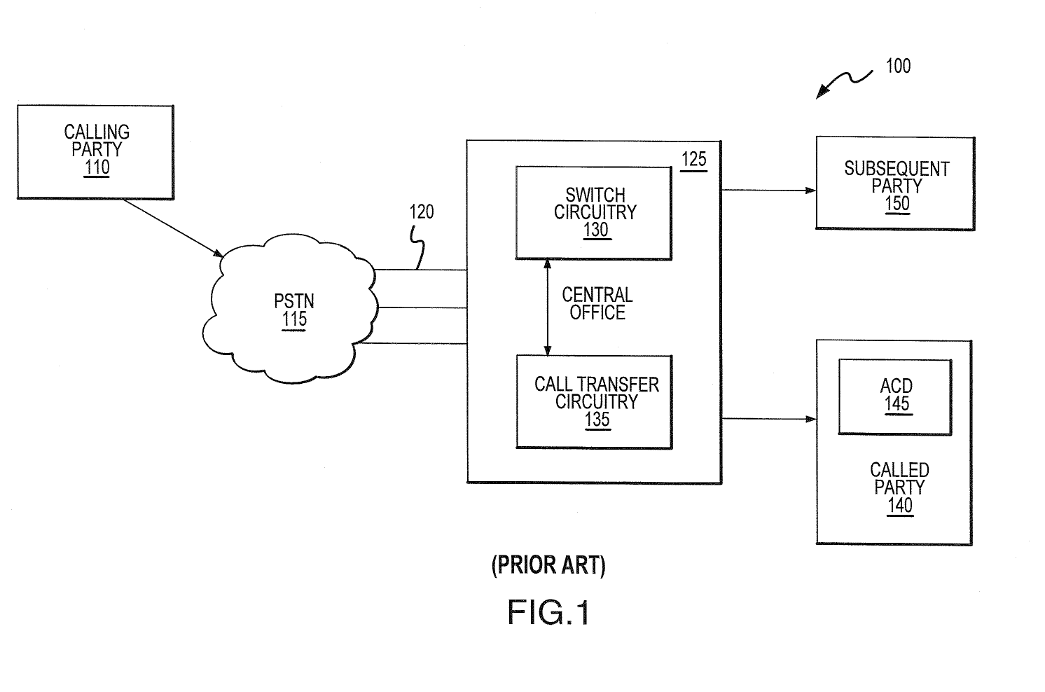

Referring initially to FIG. 1, illustrated is an environment 100 with which a system for automatically transferring a telephone call can operate. The environment 100 includes a calling party 110 coupled to the PSTN 115. The environment 100 further includes a CO 125 coupled to the PSTN 115 via several trunks of the PSTN 115, one of which is designated 120. Within the CO 125 are switching circuitry 130 and call transfer circuitry 135 used to effect the completion of telephone calls and the supervised transfer of calls to a subsequent party.

Also included in the environment 100 are a called party 140 and a subsequent party 150. The called party 140 represents the party first called by the calling party 110. On the other hand, the subsequent party 150 represents the party to whom the telephone call between the calling party 110 and the called party 140 is to be transferred. The called party 140 and the subsequent party 150 are both coupled to the switching circuitry 130 and call transfer circuitry 135 of the CO 125, which assists in facilitating the actual transfer of the telephone call. The called party 140 includes ACD 145 so as to allow him actively to transfer the telephone call to the subsequent party 150. Specifically, if the called party 140 elects to transfer the telephone call to the subsequent party 150, the ACD 145 is used by the called party 140 to signal the call transfer circuitry 135. The call transfer circuitry 135 then activates the switching circuitry 130 which transfers the call. Thus, in the environment 100 of FIG. 1, and in the absence of a system constructed according to the teachings of the present invention, the called party 140 must actively participate in the transfer using ACD 145 dedicated to that task to have a telephone call transferred from the called party 140 to the subsequent party 150. As a result, if the subsequent party 150 represented a surveyer, conducting surveys regarding the interaction between the calling party 110 and the called party 140, the called party 140 would be required actively to transfer the telephone call to the subsequent party 150 using his ACD 145. Of course, because the called party 140 would then know the call is to be transferred to the subsequent party 150, the accuracy of any surveys conducted by the subsequent party 150 in this example may be compromised.

Alternatively, if the ACD 145 associated with the called party 140 were capable of this function, no participation by the called party 140 would be required to transfer calls automatically. However, to transfer calls automatically to varying subsequent parties 150 such ACD would need reprogramming or other modification each time the subsequent party 150 changes. Those skilled in the art understand the complexity of an ACD and the high cost associated with reprogramming or otherwise modifying an ACD to initiate the automatic transfer of calls to subsequent parties 150.

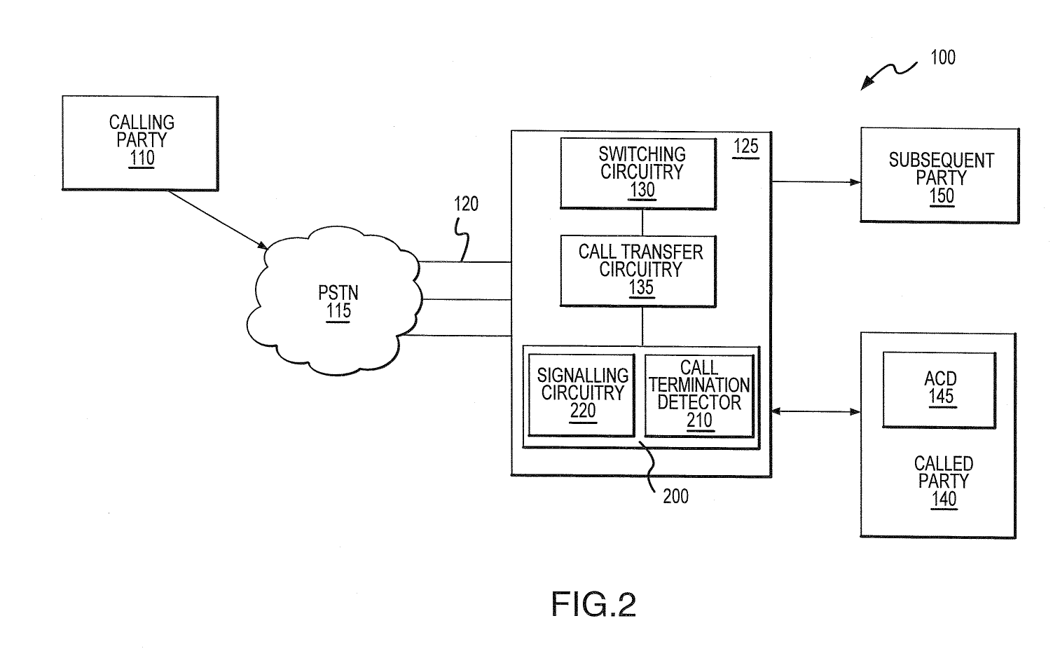

Turning now to FIG. 2, illustrated is a system 200 for automatically transferring a telephone call from one party to another, within the environment 100 of FIG. 1, constructed according to the principles of the present invention. The environment 100 still includes the calling party 110, the PSTN 115, the trunk lines 120, and the CO 125 having the switching circuitry 130 and the call transfer circuitry 135 illustrated in FIG. 1. The environment 100 further includes the called party 140 and the subsequent party 150.

In one embodiment of the present invention, the called party 140 is an inbound calling center, built around the ACD 145 having an ACD and including an attendant bank. In such embodiment, surveying the performance of the attendant bank without modifying operation of the ACD or alerting the attendant bank to the presence of the survey is highly advantageous. Thus, as discussed above, because of the high cost, both in money and time, of reprogramming or otherwise modifying an ACD, a call transfer system capable of automatically transferring calls without modifying or reprogramming the ACD would be advantageous to the called party 140.

In a related embodiment, the subsequent party 150 is a surveyer that surveys the calling party 110 regarding the interaction between the calling party 110 and the called party 140. In such embodiment, the surveyer may include an IVR, a voice recognition unit, or may simply be a live operator. Of course, the present invention does not limit the manner in which surveys are conducted, and the surveyer may act in any conventional or later-discovered manner to survey the calling party 110 with respect to his interaction with the called party 140.

FIG. 2 further illustrates a system 200 for automatically transferring a telephone call from one party to another constructed according to the principles of the present invention. The system 200 is shown coupled to the call transfer circuitry 135 within the CO 125. Although illustrated within the CO 125, in an alternative embodiment of the present invention, the system 200 may be located external the CO 125. Of course, the system 200 of the present invention is not limited to any one location.

The system 200 includes a call termination detector 210 for determining when the called party 140 terminates the telephone call with the calling party 110. The system 200 further includes signaling circuitry 220, associated with the call termination detector 210, for signaling the call transfer circuitry 135 to transfer the telephone call from the called party 140 to the subsequent party 150. However, the signaling circuitry 220 is not associated with the called party 140, or any of the ACD 145 associated with called party 140, and therefore operates independently therefrom.

The system 200 functions as follows. When the calling party 110 places a telephone call to the called party 140, the call termination detector 210 of the system 200 intercepts the incoming call. Although the system 200 intercepts the incoming call, it does not interrupt it or otherwise alert the called party 140 that the incoming call has been intercepted. The system 200 then allows the call transfer circuitry 135 to activate the switching circuitry 130 to complete the call. After the call is connected, the call termination detector 210 then monitors the call for its termination by the called party 140. When the calling party 110 and the called party 140 have finished their conversation, the calling party 110 waits for the called party 140 to terminate the line connection.

Once the call is terminated by the called party 140, the call termination detector 210 detects that the conversation between the two parties 110, 140 has ended and initiates the signaling circuitry 220. The signaling circuitry 220 then signals the call transfer circuitry 135, which in turn activates the switching circuitry 130, to automatically transfer the telephone call from the called party 140 to the subsequent party 150. In the embodiment illustrated in FIG. 2, the signaling circuitry 220 employs DTMF signaling to signal the call transfer circuitry 135 to initiate the transfer of the telephone call from the called party 140 to the subsequent party 150. In an alternative embodiment of the present invention, the signaling circuitry 220 signals the call transfer circuitry 135 in-band. Out-of-band signaling can, however, also be employed and is within the broad scope of the present invention. Those skilled in the art understand the benefits of differing methods of signaling, and the present invention is not limited to any one method.

Irrespective of the type of signaling employed by the signaling circuitry 220, in a preferred embodiment of the present invention the called party 140 and his ACD 145 are unable to detect the transfer of the telephone call. Specifically, a preferred embodiment of the system 200 requires no modification to the called party's 140 ACD 145 and no active participation by the called party 140. In addition, assuming the ACD 145 of the called party 140 were even capable of performing the function, none of the costly reprogramming of the ACD is necessary, resulting in substantial savings to the called party 140 while retaining the benefits of automatic call transferring. Moreover, the system 200 of the present invention operates transparently with respect to the ACD 145 and the called party 140. As a result, the blindness of surveys that may be conducted with respect to the called party 140 is enhanced.

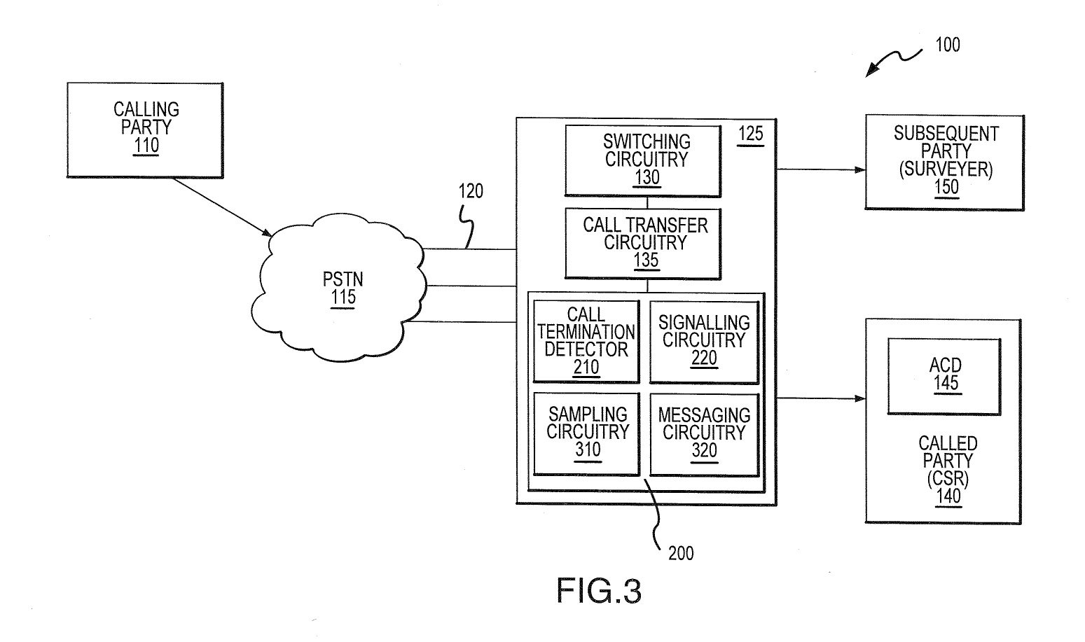

Turning now to FIG. 3, illustrated is a surveying system 300, incorporating the system 200 of FIG. 2 and the environment 100 of FIG. 1, constructed according to the principles of the present invention. The surveying system 300 still includes the calling party 110, the PSTN 115, the trunk lines 120, and the CO 125 having the switching circuitry 130 and the call transfer circuitry 135. Furthermore, the surveying system 300 incorporates the system 200 of FIG. 2 having the call termination detector 210 and the signaling circuitry 220.

The surveying system 300 in FIG. 3 further includes the called party 140, as well as the subsequent party 150. However, in the illustrated embodiment, the called party 140 is a CSR and the subsequent party 150 is a surveyer conducting customer satisfaction surveys regarding the performance of the CSR (i.e., the called party 140). Of course, those skilled in the art understand that the surveying system 300 is not limited to conducting customer satisfaction surveys, and that any type of survey is within the broad scope of the present invention.

The surveying system 300 now also includes sampling circuitry 310 and messaging circuitry 320. The sampling circuitry 310, which is associated with the call termination detector 210, selects which telephone calls are to be transferred in order to participate in the customer satisfaction survey after the termination of each call by the called party 140. The sampling circuitry 310 selects telephone calls for participation in the survey pseudo-randomly, according to some function or other manner. However, the present invention is not limited to a particular method of selecting telephone calls for transfer, and is broad enough to encompass any method of selection, either now existing or later developed.

The messaging circuitry 320, which is also associated with the call termination detector 210, transmits a message regarding the future transfer of the telephone call to the calling party 110 before the calling party 110 is connected to the called party 140. In the illustrated embodiment, the messaging circuitry 320 asks the calling party 110 the favor of staying on the line in order to participate in the customer satisfaction survey after the called party 140 terminates the telephone call. Thus, the calling party 110 is informed that an automatic transfer will take place upon termination of the telephone call by the called party 140 and is dissuaded from hanging up after his interaction with the called party 140 is concluded.

Delivering the message to the calling party 110 before the called party 140 is on the line advantageously prevents the called party 140 from becoming aware of the survey regarding his own performance. By preventing the called party 140 from becoming aware of the imminent survey, a more accurate survey regarding a CSR's true performance is possible. In yet another alternative embodiment, the messaging circuitry 320 may otherwise inform or prompt the calling party 110, upon placing the telephone call, in any advantageous manner.

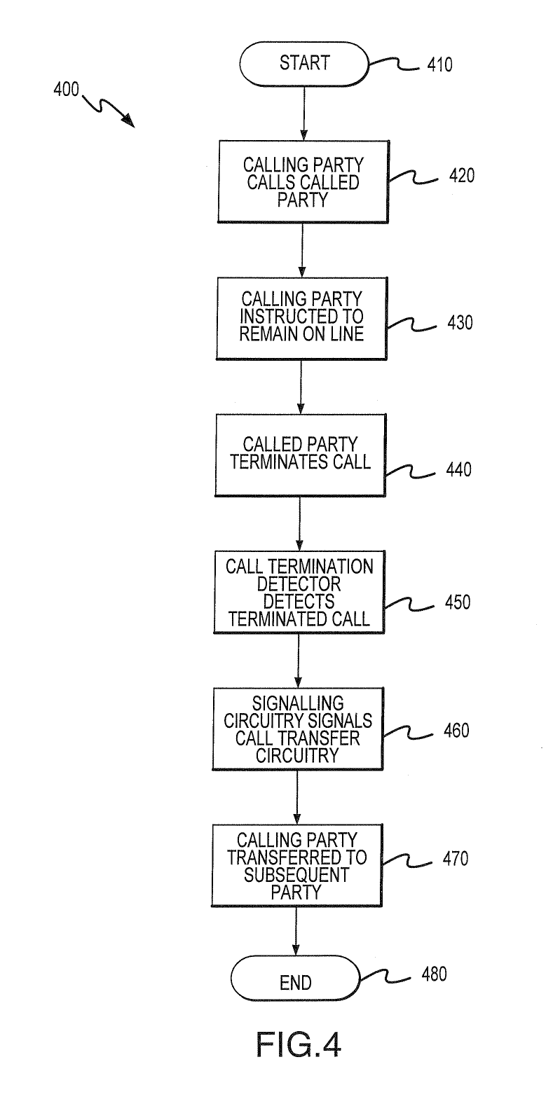

Turning now to FIG. 4, illustrated is a flow diagram 400 of a method of automatically transferring a telephone call from the called party 140 to the subsequent party 150 according to the principles of the present invention. The method begins in a step 410.

In a step 420, the calling party 110 places a telephone call to the called party 140 regarding a particular subject. Before the calling party 110 is connected to the called party 140, the calling party 110 is given an instruction in a step 430. Specifically, the calling party 110 is instructed (or requested, as the case may be) to remain on the line after the called party 140 terminates the telephone call. In an alternative embodiment of the present invention, only certain calling parties may be selected by sampling circuitry 310 to remain on the line after the called party 140 terminates the telephone call.

In a step 440, the called party 140 terminates the telephone call with the calling party 110. Once the called party 140 terminates the telephone call, the call termination detector 210 determines the termination and, in response, initiates the signaling circuitry 220 in a step 450. In a step 460, the signaling circuitry 220 signals the call transfer circuitry 135 to transfer the calling party 110 to the subsequent party 150. In a step 470, the call transfer circuitry 135 activates the switching circuitry 130 and automatically transfers the telephone call from the calling party 110 to the subsequent party 150 without any assistance or direction from the called party 140 or any ACD 145 associated with the called party 140. As a result, the calling party 110 can be automatically transferred to the subsequent party 150 upon his completion of the call with the called party 140 without the called party's 130 knowledge of, or participation in, the transfer. The method of automatically transferring a telephone call from a called party 140 to a subsequent party 150 illustrated in FIG. 4 ends in a step 480.

As is clear from the description above, as a result of the called party 140 terminating the telephone call with the calling party 110, the system 200 of the present invention, or the surveying system 300 incorporating the system 200, automatically transfers the call to the subsequent party 150 without requiring the ACD 145 associated with the called party 140 to cause the transfer or be modified or reprogrammed in any manner. Moreover, the present invention automatically transfers calls without requiring action on the part of either the calling party 110 or the called party 140. In short, the present invention enjoys substantial utility in that no transfer equipment associated with the called party 140 needs to be modified to effect automatic transfers, and such transfers are transparent to the called party 140, and his ACD 145, thereby enhancing the blindness of surveys taken with respect to interactions between the calling party 110 and the called party 140.

Although the present invention has been described in detail, those skilled in the art should understand that they can make various changes, substitutions and alterations herein without departing from the spirit and scope of the invention in its broadest form.

What is claimed is:

1. For use with call transfer circuitry associated with a central office, a system for automatically transferring a telephone call from a called party to a subsequent party, comprising:
a call termination detector that detects termination of said telephone call by said called party; and
signaling circuitry, associated with said call termination detector and dissociated from said called party, that, in response to said termination, signals said call transfer circuitry to automatically transfer said telephone call to said subsequent party without requiring equipment associated with said called party to cause said transfer.

2. The system as recited in claim 1 wherein said system is collocated with said call transfer circuitry.

3. The system as recited in claim 1 wherein said signaling circuitry signals said call transfer circuitry in-band.

4. The system as recited in claim 1 wherein said called party and said equipment are unable to detect said transfer.

5. The system as recited in claim 1 further comprising sampling circuitry, associated with said call termination detector, that selects said telephone call for said transfer in response to said termination.

6. The system as recited in claim 1 further comprising messaging circuitry, associated with said call termination detector, that transmits a message regarding said transfer to a calling party of said telephone call before said calling party is connected to said called party.

7. The system as recited in claim 1 wherein said signaling circuitry signals said call transfer circuitry to automatically transfer said telephone call to said subsequent party without requiring permission from said calling party.

8. For use with call transfer circuitry associated with a central office, a method of automatically transferring a telephone call from a called party to a subsequent party, comprising:
detecting termination of said telephone call by said called party; and
in response to said termination, signaling said call transfer circuitry to automatically transfer said telephone call to said subsequent party without requiring equipment associated with said called party to cause said transfer.

9. The method as recited in claim 8 wherein said system is collocated with said call transfer circuitry.

10. The method as recited in claim 8 wherein said signaling circuitry signals said call transfer circuitry in-band.

11. The method as recited in claim 8 wherein said called party and said equipment are unable to detect said transfer.

12. The method as recited in claim 8 further comprising sampling circuitry, associated with said call termination detector, that selects said telephone call for said transfer in response to said termination.

13. The method as recited in claim 8 further comprising messaging circuitry, associated with said call termination detector, that transmits a message regarding said transfer to a calling party of said telephone call before said calling party is connected to said called party.

14. The method as recited in claim 8 wherein said subsequent party comprises a surveyer that surveys a calling party of said call regarding interaction between said calling party and said called party.

15. For use with call transfer circuitry associated with a central office, a surveying system, comprising:
sampling circuitry that selects a telephone call to be surveyed from a plurality of telephone calls destined for a called party;
messaging circuitry, associated with said sampling circuitry, that transmits a message to a calling party of said telephone call before said calling party is connected to said called party;
a call termination detector, associated with said messaging circuitry, that detects termination of said telephone call by said called party;
signaling circuitry, associated with said call termination detector and dissociated from said called party, that, in response to said termination, signals said call transfer circuitry to automatically transfer said telephone call to a subsequent party without requiring equipment associated with said called party to cause said transfer; and
a surveyer, associated with said subsequent party, that surveys said calling party regarding interaction between said calling party and said called party.

16. The system as recited in claim 15 wherein said system is collocated with said call transfer circuitry.

17. The system as recited in claim 15 wherein said signaling circuitry signals said call transfer circuitry in-band.

18. The system as recited in claim 15 wherein said called party and said equipment are unable to detect said transfer.

19. The system as recited in claim 15 wherein said surveyer comprises an interactive voice response unit.

20. The system as recited in claim 15 wherein said called party is an inbound call center.
